(19) United States
(12) Patent Application Publication
(10) Pub. No.: US 2025/0074478 A1
(43) Pub. Date: Mar. 6, 2025

(54) BOGIE FOR A RAIL VEHICLE WITH TWO LONGITUDINAL MEMBERS, A TRACTION MOTOR AND A COOLING DEVICE AS WELL AS A RAIL VEHICLE WITH AT LEAST ONE BOGIE

(71) Applicant: Stadler Rail AG, Bussnang (CH)

(72) Inventor: Ewald FALKE, St. Gallen (CH)

(73) Assignee: Stadler Rail AG, Bussnang (CH)

(21) Appl. No.: 18/817,522

(22) Filed: Aug. 28, 2024

(30) Foreign Application Priority Data
Aug. 29, 2023 (EP) 23193842.4

(51) Int. Cl. B61C 3/00

(52) U.S. Cl. CPC B61C 3/00

(57) ABSTRACT

The invention relates to a bogie (10) for a rail vehicle (29). The bogie (10) comprises a bogie frame (11) with two longitudinal beams (8), a traction motor (1) with a motor shaft (15) and a cooling device (14). The traction motor (1) can be cooled by the cooling device (14). The traction motor (1) is arranged between the longitudinal beams (8). The cooling device (14) comprises a fan (2) and a fan drive (4). The fan drive (4) can be designed as an electric permanent magnet motor. The cooling device (14) is arranged between the longitudinal beams (8).

The invention also relates to a rail vehicle (29) with a bogie (10) as described above.

This application claims priority to European patent application serial no. 23193842.4 filed Aug. 29, 2023.

### FIELD OF THE INVENTION

The present invention relates to a bogie for a rail vehicle with two longitudinal members, a traction motor and a cooling device, and to a rail vehicle with at least one bogie.

### BACKGROUND OF THE INVENTION

Motor bogies with traction motors to be cooled are known from the prior art. For example, EP 3 472 020 and EP 2 695 791 disclose motor bogies with traction motors to be cooled. However, these motor bogies are equipped with bulky and voluminous cooling devices. Such bogies therefore require a large amount of installation space. Also known from the prior art are bogies with traction motors that are cooled by cooling devices arranged outside the bogies. Such a bogie is known, for example, from DE 3118055. In such a configuration, air ducts and air openings are required in the side walls of the rail vehicle, in the range of the roof slope of the rail vehicle or on the roof itself. For this reason, such bogies or cooling devices also require a large installation space.

Bogies in which a cooling device is arranged directly on the motor shaft and connected to the motor shaft are also known from the prior art. Such an arrangement is known, for example, from EP 1 100 184. As such fans are connected directly to the motor shaft, the speed of the fan is identical to the speed of the motor. This means that the traction motors cannot be cooled as required. With such devices, the highest speed of the motor necessarily results in the largest air flow rate. This results in high noise levels and high mechanical losses.

Self-ventilated motors with a fan driven independently of the traction motor are also known from the prior art. Such devices are disclosed in EP 1 109 297 and EP 3 819 148. In these documents, however, the cooling device is not arranged on the bogie. These devices are therefore also complex in design, have many lines and require a large installation space.

The motor bogies known from the prior art thus have the disadvantage that they do not enable cooling of the motor as required and/or that they require a very large installation space.

### SUMMARY OF THE INVENTION

It is the object of the invention to overcome the disadvantages of the prior art and, in particular, to create a bogie for a rail vehicle in which the motor can be cooled as required and which requires a small installation space.

The object is solved by a bogie for a rail vehicle with two longitudinal members, a traction motor and a cooling device and by a rail vehicle with at least one bogie according to the independent patent claims.

In particular, the object is solved by a bogie for a rail vehicle. The bogie comprises a bogie frame with two longitudinal beams and a traction motor with a motor shaft. The traction motor is arranged between the longitudinal members. In addition, the bogie comprises a cooling device by means of which the traction motor can be cooled. The cooling device comprises a fan and a fan drive that can be operated independently of the speed of the motor shaft. The cooling device is arranged between the longitudinal beams. The fan drive can be designed as an electric permanent magnet motor.

In such a bogie, the motor can be cooled as required. In addition, such a bogie has a small installation space. Preferably, the bogie has four wheels and at least two wheelset axles. The motor shaft and the fan shaft are not mechanically connected, so that the fan and the fan drive can be operated independently of the traction motor and the motor shaft on such a bogie. This means that the motor shaft and the traction motor can be operated at a first speed and the fan drive can be operated at a different, demand-orientated second speed. The traction motor can have an axial length in the direction of its motor shaft of 50 cm-75 cm. The fact that the traction motor and the cooling device are arranged between the longitudinal beams means that the traction motor and the cooling device are arranged between the longitudinal beams in the plan view of the properly arranged bogie.

The energy and power requirement of such a cooling device is significantly reduced, as the required air volume is not obstructed by longer ducts and restrictive bends in the ducts. As a result, such a cooling device can be advantageously dimensioned and less energy needs to be provided for the cooling device on a rail vehicle. The fan drive can comprise a conventional asynchronous motor. The fan drive can also comprise a permanent magnet motor. If the fan drive is designed as a permanent magnet motor, the fan drive can be made very small and efficient.

The motor shaft may have a first axis of rotation and the fan may have a second axis of rotation. The first axis of rotation and the second axis of rotation can be essentially orthogonal to the direction of travel. The first axis of rotation and the second axis of rotation can be parallel and spaced apart. The first axis of rotation and the second axis of rotation can be identical.

It is possible for the first axis of rotation and the second axis of rotation to be arranged one after the other in the same orientation in the direction of travel. The fact that the first axis of rotation and the second axis of rotation are identical means that the first axis of rotation and the second axis of rotation are aligned.

Such an arrangement allows the bogie to be manufactured in a compact and stable manner. An arrangement that is essentially orthogonal to the direction of travel enables an advantageous power transmission from the motor shaft to the other drive train.

Even if the first axis of rotation and the second axis of rotation are identical, the motor shaft and the fans can rotate independently of each other at different speeds. The motor shaft and the fan are therefore not directly connected mechanically, even if the first axis of rotation and the second axis of rotation are identical. It is therefore possible that even if the first axis of rotation and the second axis of rotation are identical, the motor shaft has a first speed and the fan has a different second speed.

It is possible for the traction motor and/or the fan and/or the fan drive to be arranged at least partially between two wheels of an axle of the bogie.

With such an arrangement, the bogie can be built simply and compactly and the power transmission from the traction motor to the wheels is uncomplicated and efficient. In addition, the weight of the traction motor and/or the fan and/or the fan drive can be advantageously transferred to the rails via the wheels and the corresponding components can be advantageously dimensioned.

Between the wheels means that the cooling device and the wheels at least partially overlap in their contour in a direction essentially orthogonal to the direction of travel.

It is possible that the fan drive is arranged closer to one of the wheels orthogonal to the direction of travel than the drive motor and the fan.

The fan drive is thus arranged on an outer side of the components and not between the drive motor and the fan. This arrangement of the fan drive ensures that the fan drive does not heat up too much. The fan is driven by the fan drive and the air is moved by the fan from the drive motor to the fan and then to the fan drive. This means that the fan not only cools the traction motor, but also the fan drive.

It is possible for the bogie to have a gearbox that mechanically connects the motor shaft and the at least one wheelset shaft. The traction motor and the fan can be arranged orthogonally to the direction of travel between the fan drive and the gearbox.

Such an arrangement enables good cooling of the motor and space-saving and efficient transmission of torque from the traction motor to the wheelset shaft through the gearbox.

The gearbox can be a gear transmission.

It is possible that the cooling device can be supplied with electric current by a cooling converter.

By arranging a cooling converter in this way, it is possible to operate the cooling device independently of the motor. In addition, the cooling converter can be repaired or replaced independently of other components. The cooling converter can be formed on the bogie. It is also possible that the cooling converter is not formed on the bogie.

It is possible for a bogie to have several cooling devices, with one cooling inverter being formed for each cooling device.

This makes it possible to supply each cooling device of a bogie or a rail vehicle individually with energy and to operate it independently if several cooling devices are provided in a bogie or in a rail vehicle. It is therefore not necessary to have a central inverter for all fan drives.

It is possible for each cooling device to be assigned to a traction motor. In this case, each traction motor to which a cooling device is assigned can be cooled individually. This makes it possible for the traction motors to be used with a different load and then cooled according to the respective load of the traction motor. This reduces the overall energy demand for cooling the motors of the rail vehicle.

It is possible that the traction motor is arranged in a motor housing and that the fan and the fan drive are arranged in a cooling housing. The motor housing is fluidically connected to the cooling housing, whereby the cooling housing is detachably flange-mounted to the motor housing.

If defects occur in the cooling system, the entire cooling housing of the cooling device with the fan and the fan drive can be removed from the motor housing. This makes it possible to attach a functioning, different cooling device with a different cooling housing to the motor housing. The rail vehicle with the bogie is then quickly ready for use again and the repair time is minimised.

It is also possible to repair the cooling device at another location where specialised tools may be available. By forming a cooling housing and a motor housing, the bogie is therefore particularly easy to maintain and can be quickly returned to service in the event of a defect.

It is possible for the cooling housing to have an axial air inlet and a radial air outlet.

In this way, the air can be drawn in and expelled from the fan blades in an advantageous manner.

The air inlet can be provided with a filter. It is possible for the air inlet and/or the air outlet to have several slot-shaped openings. It is also possible for the air inlet and/or the air outlet to have several oval or round openings.

It is possible for the longitudinal members to have a maximum expansion of 2.4 times to 3.6 times the expansion of the traction motor in a direction axially along the motor shaft. It is possible for the longitudinal members to have a maximum expansion in a direction axially along the motor shaft of 2.6 times to 3.4 times the expansion of the traction motor in a direction axially along the motor shaft.

The expansion of the traction motor does not include the expansion of the gearbox, the expansion of a motor-gearbox coupling or the xpansion of brake calipers.

Such a design ensures that the cooling device can also be arranged between the longitudinal members in addition to the traction motor.

It is possible that the bogie comprises at least one sensor with which the temperature of the traction motor can be determined. The temperature sensor can be arranged on the motor housing and/or on a rotor of the traction motor and/or on a stator of the traction motor. The bogie can comprise a fan control unit. The controller can be connected to the fan drive and to the temperature sensor using data technology. It is then possible to control the speed of the fans depending on the measured data from the temperature sensor.

The object of the invention is furthermore solved by a rail vehicle with at least one bogie as described above.

Such a rail vehicle has essentially the same advantages as a bogie as described above.

It is possible that each bogie of the rail vehicle is designed as a bogie as described above. It is also possible that the rail vehicle comprises driven rail vehicle carriages, which are equipped with a bogie as described above, as well as non-driven rail vehicle carriages, which are designed with non-driven bogies. The powered carriages of the rail vehicle may be end cars. It is also possible that the driven rail vehicle wagons of the rail vehicle are centre cars and the end cars are not driven. It is also conceivable that a rail vehicle carriage comprises a bogie as described above and a non-driven bogie.

### BRIEF DESCRIPTION OF THE DRAWINGS

The invention is explained in more detail in the following figures.

They show:

FIG. 1: A traction motor with a cooling device,

FIG. 2: a bogie with a traction motor and a cooling device,

FIG. 3: a rail vehicle with two bogies,

FIG. 4: a rail vehicle with two rail vehicles and a coupling.

### DETAILED DESCRIPTION OF THE PREFERRED EMBODIMENTS

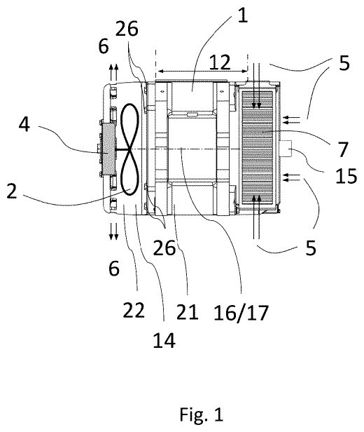

FIG. 1 shows a traction motor 1 with a cooling device 14. The cooling device 14 has a fan 2 and a fan drive 4. The cooling device 14 with the fan 2 and the fan drive 4 is arranged in a cooling housing 22. The drive motor 1 has a motor shaft 15. The traction motor 1 is arranged in a motor housing 21. The motor shaft 15 has a first axis of rotation 16. The fans 2 has a second axis of rotation 17. The first axis of rotation 16 of the motor shaft 15 is identical to the second axis of rotation 17 of the fan 2. The cooling housing 22 is flange-mounted to the motor housing 21 by means of several screws 26. The cooling housing 22 with the fan drive 4 and the fan 2 can thus be easily removed from the motor housing 21 by loosening the screws 26. It is thus possible for a cooling device 14 to be removed from the traction motor 1 and repaired in a workshop, while a further cooling device 14 is attached to the traction motor 1 immediately after the first cooling device 14 has been removed. The cooling device 14 can thus be quickly replaced and the rail vehicle (not shown) can be quickly put back into operation, while the cooling device 14 is maintained in a workshop and the rail vehicle is operated with a further cooling device 14. The cooling housing has air outlets 6. The air outlets 6 are formed radially to the first axis of rotation 16 and radially to the second axis of rotation 17 in the cooling housing 22. In the range of the air inlets 5, an air filter 7 is arranged in the motor housing 21. In the range of the air filter 7, the engine housing 21 has air inlets 5 through which air from the environment can flow into the air filter 7. The air inlets 5 of the engine housing 21 are arranged both axially and radially. The motor shaft 15 passes through the air filter 7, which means that the air filter 7 is arranged at least partially around the motor shaft 15. The traction motor 1 has an overall length 12. The overall length 12 is dimensioned axially along the first axis of rotation 16. Axially along the first axis of rotation 16, the components are thus arranged in the following order: Fan drive 4, fan 2, traction motor 1, air filter 7. The air is sucked by the fan 2 of the cooling device 14 in the cooling housing 22 from the air inlets 5 into the air filter 7 into the motor housing 21 past the traction motor 1 into the cooling housing 22 and is then expelled from the cooling housing 22 by the fan 2 in the radial direction of the first axis of rotation 16 and the second axis of rotation 17. The fan 2 thus draws in the air in an axial direction and in a radial direction of the first axis of rotation 16 and the second axis of rotation 17 through the air inlets 5 of the motor housing 5. Subsequently, the fan 2 sucks the air in an axial direction substantially parallel to the first axis of rotation 16 and the second axis of rotation 17 through the cooling housing 22 past the traction motor 1 and expels the air through the air outlets 6 in a direction radial to the first axis of rotation 16 and the second axis of rotation 17 from the air outlets 6 of the cooling housing 22.

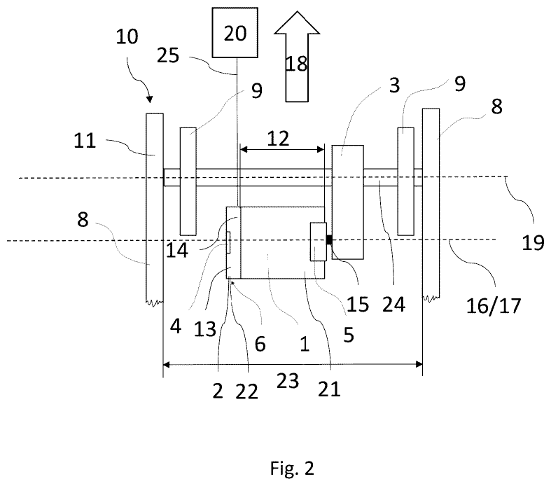

FIG. 2 shows a bogie with a traction motor 1 and a cooling device 14. The traction motor 1 is arranged in a motor housing 21. The cooling device 14 comprises a fan 2 and a fan drive 4. The cooling device 14 is formed in a cooling housing 22. The traction motor 1 is formed in a motor housing 21. The cooling housing 22 is flange-mounted to the motor housing 21. The traction motor 1 in the motor housing 21 has an overall length 12. The overall length 12 is dimensioned in an axial direction along the first axis of rotation 16 and the second axis of rotation 17. The first axis of rotation 16 and the second axis of rotation 17 are identical. A motor shaft 15 is formed on the drive motor 1. The cooling device 14 in the cooling housing 22, the traction motor 1 in the motor housing 21 and the gearbox 3 are arranged between the longitudinal beams 8 of the bogie frame 11 of the bogie 10. In addition, the cooling device 14 is arranged in the cooling housing 22, the traction motor 1 is arranged in the motor housing 21 and the gearbox 3 is arranged between the wheels 9. Between the wheels means that the cooling device 14 and the wheels 9 at least partially overlap in their contour in a direction essentially orthogonal to the direction of travel 18. The components are formed in a direction axially along the first axis of rotation 16 and the second axis of rotation 17 in the following sequence: Cooling housing 22 with the fan drive 4 as well as the fan 2, motor housing 21 with the drive motor 1, gearbox 3. The fan 2 is arranged between the fan drive 4 and the drive motor 1. The longitudinal members have a distance 23 in one axial direction of the first axis of rotation 16 and the second axis of rotation 17. The distance 23 is 205 cm. The overall length of the traction motor 12 is 65 cm. The distance 23 is therefore around 3.2 times the overall length of the traction motor 12. These ratios must of course be adapted for bogies with internal bearings. The gearbox 3 mechanically connects the motor shaft 15 with the wheelset shaft 24. The wheelset shaft 24 has a third axis of rotation 19. The third axis of rotation 19 is parallel to the first axis of rotation 16 and the second axis of rotation 17, and both the first axis of rotation 16 and the second axis of rotation 17 and the third axis of rotation 19 are orthogonal to the direction of travel 18. The wheelset shaft 24 is mechanically connected to the wheels 9. The wheelset shaft 24 is mounted in the longitudinal members 8 of the bogie frame 11 of the bogie 10. The wheels 9 are arranged between the longitudinal members 8. The cooling device 14 as well as the traction motor 1 and the transmission 3 are thus arranged between the wheels 9, with the wheels 9 being arranged between the longitudinal members 8. The cooling device 14 is electrically connected to the cooling converter 20 by a power line 25. The cooling converter 20 is connected to the further power supply (not shown) of the rail vehicle (not shown). Thus, a cooling converter 20 is associated with the cooling device 14. The cooling converter 20 can be arranged on a bogie. The cooling converter 20 can also be formed in another range of the rail vehicle.

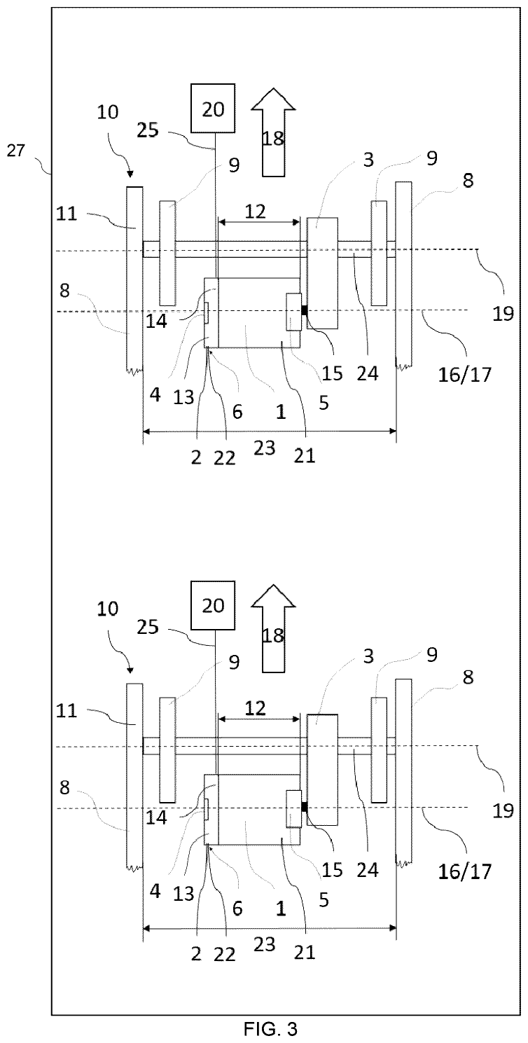

FIG. 3 shows a rail vehicle carriage 27 with two driven bogies 10. The two bogies 10 are of identical design. The details of the two bogies 10 can be seen in FIG. 2 and in the description of FIG. 2. A cooling converter 20 is assigned to each bogie 10 of the rail vehicle carriage 27. The rail vehicle carriage 27 thus comprises a cooling device 14 and a cooling inverter 20 for each bogie 10. A cooling inverter 20 is thus assigned to each cooling device 14.

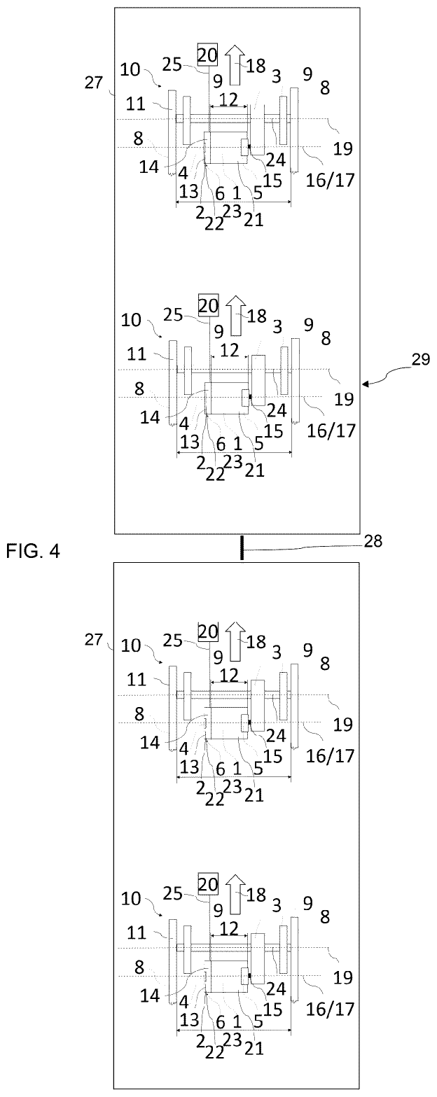

FIG. 4 shows a rail vehicle 29 with two rail vehicles 27. The rail vehicles 27 are connected by means of a coupling 28. The rail vehicle carriages 27 are designed like the rail vehicle carriage 27 in FIG. 3. The details of the rail vehicle carriages 27 can therefore be taken from FIG. 3 and the description of FIG. 3. Each rail vehicle carriage 27 has two bogies 10 analogue to FIG. 2. The details of the bogies 10 can thus be taken from FIG. 2 and the description of FIG. 2. In this example, two rail vehicles 27 thus form a rail vehicle 29. The two rail vehicles 27 are each driven. It is possible that the two rail vehicles 27 are end cars of a rail vehicle 29 and that between the two rail vehicles 27, which are designed as end cars, there are one or more non-driven rail vehicles 27. It is also possible for a rail vehicle 29 to consist exclusively of driven rail vehicles. The driven rail vehicle carriages 27 can also be designed as centre cars. In this case, further non-powered carriages are formed in front of and behind the rail vehicle carriage in the direction of travel. It is also possible for a rail vehicle carriage 27 to have a driven bogie 10 and a non-driven bogie 10.

1. A bogie for a rail vehicle, comprising a bogie frame with two longitudinal beams, a traction motor with a motor shaft, wherein the traction motor is arranged between the longitudinal beams, a cooling device by which the traction motor can be cooled, wherein the cooling device comprises a fan and a fan drive which can be operated independently of a rotational speed of the motor shaft wherein the cooling device is arranged between the longitudinal beams.

2. The Boogie according to claim 1, wherein the motor shaft has a first axis of rotation and wherein the fans has a second axis of rotation, wherein the first axis of rotation and the second axis of rotation are essentially orthogonal to the direction of travel.

3. The bogie according to claim 1, wherein at least one of the traction motor and/or the fan and the fan drive are arranged at least partially between two wheels of an axle of the bogie.

4. The bogie according to claim 3, wherein the fan drive is arranged orthogonally to the direction of travel closer to one of the wheels than the traction motor and the fan.

5. The bogie according to claim 1, wherein the bogie has a transmission which mechanically operatively connects the motor shaft and at least one wheelset shaft, the traction motor and the fan being arranged orthogonally to the direction of travel between the fan drive and the transmission.

6. The bogie according to claim 1, wherein the cooling device is supplied with electric current by a cooling converter.

7. The bogie according to claim 6, wherein the bogie has a plurality of cooling devices, one cooling converter being formed for each cooling device.

8. The bogie according to claim 1, wherein the traction motor is arranged in a motor housing, wherein the fan and the fan drive are arranged in a cooling housing, wherein the motor housing and the cooling housing are fluidically connected, wherein the cooling housing is detachably flanged to the motor housing.

9. The Boogie according to claim 8, wherein the cooling housing has an axial air inlet and a radial air outlet.

10. The bogie according to claim 1, wherein the distance of the longitudinal members in a direction axially along the motor shaft is 2.4 times to 3.6 times and the expansion of the traction motor in a direction axially along the motor shaft.

11. A rail vehicle with at least one bogie according to claim 1.
